(19) United States
(12) Patent Application Publication
(10) Pub. No.: US 2014/0075913 A1
(43) Pub. Date: Mar. 20, 2014

(54) Mower Deck Extension

(71) Applicant: WALKER MANUFACTURING, INC., Ft. Collins, CO (US)

(72) Inventors: Dean M. Walker, Ft. Collins, CO (US); Ted W. Walker, Ft. Collins, CO (US)

(73) Assignee: WALKER MANUFACTURING, INC., Ft. Collins, CO (US)

(21) Appl. No.: 13/622,357

(22) Filed: Sep. 18, 2012

(51) Int. Cl. A01D 34/81; A01D 34/73

(52) U.S. Cl. CPC A01D 34/81; A01D 34/73
USPC 56/255; 56/320.1

(57) ABSTRACT

A round mower deck for a rotary lawn mower may have a leading edge extension near the sides of the deck to improve cutting performance at the edge of a cutting swath. The leading edge extension may be mounted on an otherwise curved leading edge of a mower deck within the last few inches of the deck width. The leading edge extension may overlap some portion of the cutting stroke of a blade, and may prevent grass from being deflected away from the blade, resulting in a poor cut near the edge of a cutting swath. In some cases, the extension may be removable and may be added to an existing mower deck.

### BACKGROUND

A conventional rotary lawn mower uses a blade that rotates on a vertical axis to cut grass as the mower moves forward. Such mowers have a deck or shroud that encases the blade to prevent people, animals, and other objects from coming into contact with the spinning blade.

In many cases, the deck may be rounded to closely follow the motion of the blade. Such lawn mowers may use airflow generated by the moving blade to pull grass clippings out of the lawn and into a discharge chute. A rounded deck may also allow the user to trim edges of a lawn by bringing the blade close to trees, walls, or other objects.

### SUMMARY

A round mower deck for a rotary lawn mower may have a leading edge extension near the sides of the deck to improve cutting performance at the edge of a cutting swath. The leading edge extension may be mounted on an otherwise curved leading edge of a mower deck within the last few inches of the deck width. The leading edge extension may overlap some portion of the cutting stroke of a blade, and may prevent grass from being deflected away from the blade, resulting in a poor cut near the edge of a cutting swath. In some cases, the extension may be removable and may be added to an existing mower deck.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a perspective illustration of an embodiment showing a mower deck with extensions.

FIG. 2 is a perspective illustration of an embodiment showing a detailed portion view of a mower deck from the bottom.

FIG. 3 is a bottom view illustration of an embodiment showing a detailed portion of a mower deck.

FIG. 4 is a perspective illustration of an embodiment showing a removable mower deck extension.

FIG. 5 is a perspective illustration of an embodiment showing a non-removable mower deck extension.

### DETAILED DESCRIPTION

A leading edge extension for a rounded mower deck on a rotary mower may improve grass cutting at the edge of the cutting swath. The leading edge extension may prevent grass from being bent away from the blade during forward motion, so that the blade may produce a cleaner, more efficient cut at the edge of the cutting swath.

The leading edge extension may mount on the side of a mower deck and create a leading edge that counteracts the bending motion that a blade of grass may experience near the edge of the cutting swath. In this area, the curved portion of the mower deck may force grass to bend to the side rather than forward, producing a poorer cut near the edges. The leading edge extension counteracts the outward bending tendency and produces a cleaner cut.

In experiments on a mower deck with a 42 inch nominal width, the effective cutting swath was increased by two inches by the addition of leading edge extensions on both sides of the mower deck, where the leading edge extensions had a 1.2 inch wide flat leading edge.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

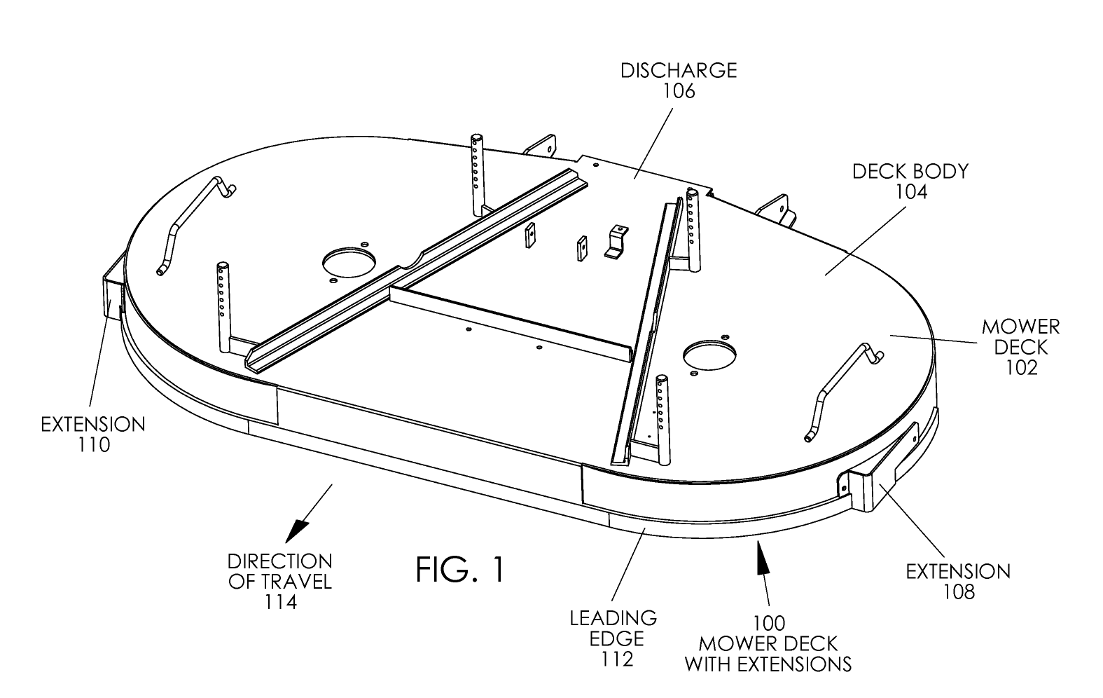

FIG. 1 is a perspective view of an embodiment 100 showing a mower deck 102 with extensions 108 and 110. The mower deck 102 may have a deck body 104 and a rear, center discharge 106. The mower deck 102 may have a forward direction of travel 114. FIG. 1 is not to scale.

The mower deck 104 may represent a multi-blade mower deck that may be used to mow grass. In the example of embodiment 100, the mower deck 104 may be a two-blade mower deck. Other embodiments may have a single blade, as well as three, four, five, six, and more blades.

The deck body 104 may be manufactured of any type of suitable material, with metal being a common material.

The mower deck 102 may have a leading edge 112. When mowing grass, the mower desk 102 may move in the direction of travel 114 and the leading edge 112 may pass through the grass prior to cutting the grass by blades rotating within the deck body 104.

The leading edge 112 may be placed at or near the actual cutting height of the blades in the mower deck. In some embodiments, the leading edge 112 may be lower than the cutting height of the blades, which may be desirable in cases where rocks, sticks, or other objects may be found in the grass while mowing.

Because the leading edge 112 may be lower than the height of the grass during mowing, the grass may be bent over as the mower moves through the grass. At the front part of the leading edge, the grass may be bent forward. Such grass may then spring back into an upright position for mowing. Grass that may be encountered near the front portion of the leading edge may have two opportunities to be cut: at the front or rear portion of the blade rotation. Such grass may have a relatively long time to recover from being bent over and thereby may be cut clean and to a constant height.

The grass that is cut near the sides of the mower deck, however, may be bent outward and away from the blades. Because the blade may have less opportunity to cut the grass at the edges and because the grass may be bent away from the blade, grass near the edges may be cut less evenly in some cases.

The extensions 108 and 110 may counteract the tendency for grass to bend away from the blades during the forward motion of the mower deck 102 through the grass. The extensions 108 and 110 may cause grass near the edges of the mower deck 102 to be bent forward, rather than to the side, and therefore the cut of the grass is improved.

In experiments with a 42 inch nominal deck size, a mower deck with extensions provided a cutting swath that was two inches wider than the same mower deck without extensions.

The extensions 108 and 110 may be removable components. In some cases, the extensions 108 and 110 may be aftermarket or third-party components that may be added to existing mower decks.

The design of the extensions 108 and 110 may take into account several competing objectives. For many mower decks, the deck may be designed with a minimum of distance between the outer edge of a blade and the outer side of the mower deck. The minimum distance may be useful in trimming or cutting grass close to trees, fences, and other objects. At the same time, the wider the width of the leading edge of the extensions, the better the cut of the blade near the edges of the deck.

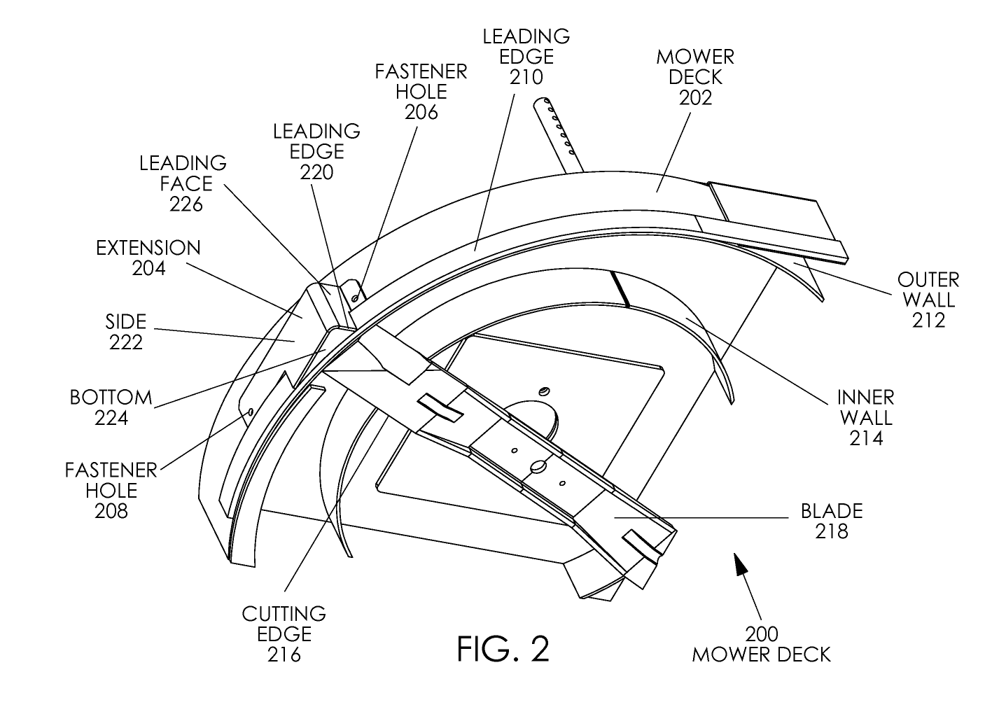

FIG. 2 is a perspective view of an embodiment 200 showing a section of a mower deck from the bottom. The mower deck 202 may have a blade 218 having a cutting edge 216, as well as an extension 204. FIG. 2 is not to scale

The mower deck 202 may have a leading edge 210, which may have an extra thickness of material around the lower portion. The leading edge 210 of a mower deck may suffer a large amount of wear, as a deck may run into rocks, stumps, stairs, curbs, and other objects that may damage the leading edge of a mower deck.

The extension 204 may be mounted to the mower deck 202 near the outside edge of the mower deck, with respect to the normal forward direction of travel. The extension 204 may have fastener holes 206 and 208, which may be used to attach the extension 204 to the mower deck 202.

The extension 204 may have a leading face 226, a side 222, and a bottom 224. The leading edge 220 may be the lower edge of the leading face 226. Embodiment 200 illustrates merely one design for an extension 204. Extension 204 may be constructed of a welded sheet metal design, a stamped sheet metal part, a cast component, or other design. The extension may be rugged to endure collisions and contact with various objects that may be in an area being mowed, such as fences, rocks, curbs, trees, and other objects. In many cases, a radius may be formed between the leading face 226 and the side 222 to minimize damage that may be caused when the extension 204 may come into contact with a tree, fence post, or other object.

The mower deck 202 may be designed with an inner wall 214 and an outer wall 212. The inner wall 214 and outer wall 212 may form a baffle or path for moving grass clippings away from the blade 218 and towards a discharge chute. In the design of the mower deck 102 in embodiment 100, the discharge chute may be located along the centerline of the mower deck.

In the example of embodiment 200, the cutting edge 216 is illustrated as travelling backwards or against the direction of travel 306 in the area of the extension 204. Such an embodiment may have clockwise rotation of the blade when viewed from the top. Other embodiments may have the cutting edge travelling along the direction of travel in the area of the extension 204. Such an embodiment may have a counter clockwise rotation of the blade when viewed from the top.

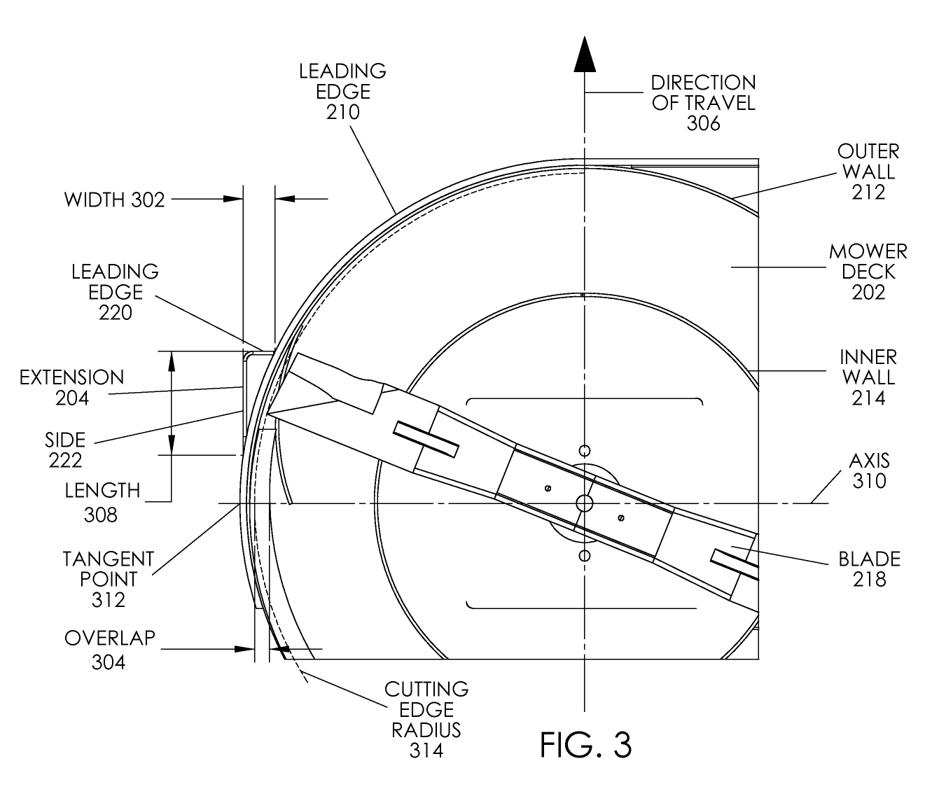

FIG. 3 is a bottom view of an embodiment 300 showing the same section of a mower deck as in embodiment 200. The mower deck 202 is shown with the blade 218, the outer wall 212, inner wall 214, and the leading edge 210. FIG. 3 is not to scale.

The extension 204 is shown with the leading edge 220 and size 222.

The illustration is oriented such that the direction of travel 306 is up. An axis 310 is drawn perpendicular to the direction of travel 306, resulting in a tangent point 312 at the side of the mower deck 202.

The leading edge 220 of the extension 204 is illustrated as being parallel to the axis 310, which is perpendicular to the direction of travel 306. In other embodiments, the leading edge may be within 30 degrees, plus or minus, with the axis 310. Other embodiments may be within plus or minus 20, 15, 10, or 5 degrees of parallel to with the axis 310.

The width 302 of the leading edge 220 may be less than 3 inches. In some embodiments, the width 302 may be less than 2.5 inches, 2.0 inches, 1.75 inches, 1.5 inches, 1.25 inches, 1 inch, 0.75 inches, or 0.5 inches.

The overlap 304 illustrates the projection of the leading edge 220 at the axis 310 with respect to the radius 314 showing the cutting edge radius. The overlap 304 is illustrated as a positive distance, which may be less than 2.0 inches, 1.5 inches, 1.25 inches, 1 inch, 0.75 inches, 0.5 inches, or 0.25 inches.

In some embodiments, the overlap 304 may be zero or negative. A negative overlap may mean that the projection of the leading edge 220 may not cross the cutting edge radius 314. While this may seem counterintuitive, such extensions have been shown to be effective. Embodiments with negative overlap may have a negative overlap greater than 0.1 inches, 0.25 inches, 0.5 inches, or 1 inch.

The length 308 may be the distance of a side 222. The length 308 may be a function of the radius of the leading edge 210 and the width 302 in some embodiments. In various embodiments, the length 308 may be less than 6 inches, 5 inches, 4 inches, 3 inches, 2 inches, or even 1 inch in some cases.

The size 222 is illustrated as flat and parallel to the direction of travel 306, but may be formed in various shapes to support the leading edge 220.

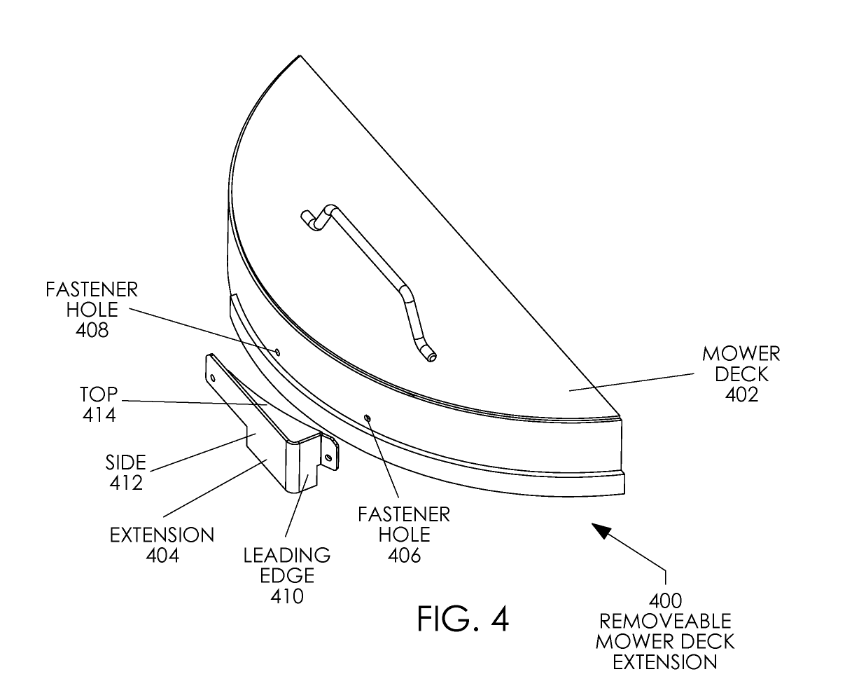

FIG. 4 is a perspective illustration of an embodiment 400 showing an exploded view of an extension 404 from a section of a mower deck 402.

The extension 404 has a leading edge 410, side 412, and top 414, as well as fastener holes that may correspond with the fastener holes 406 and 408 on the mower deck 402.

The extension 404 may be held in place by fasteners, although other embodiments may have other attachment mechanisms. In some embodiments, the extension may be removable. In such embodiments, an operator may elect to remove the extensions to allow for easier trimming around various objects, such as trees or bushes, then reattach the extensions when mowing open area or when a cleaner mowed edge may be desired.

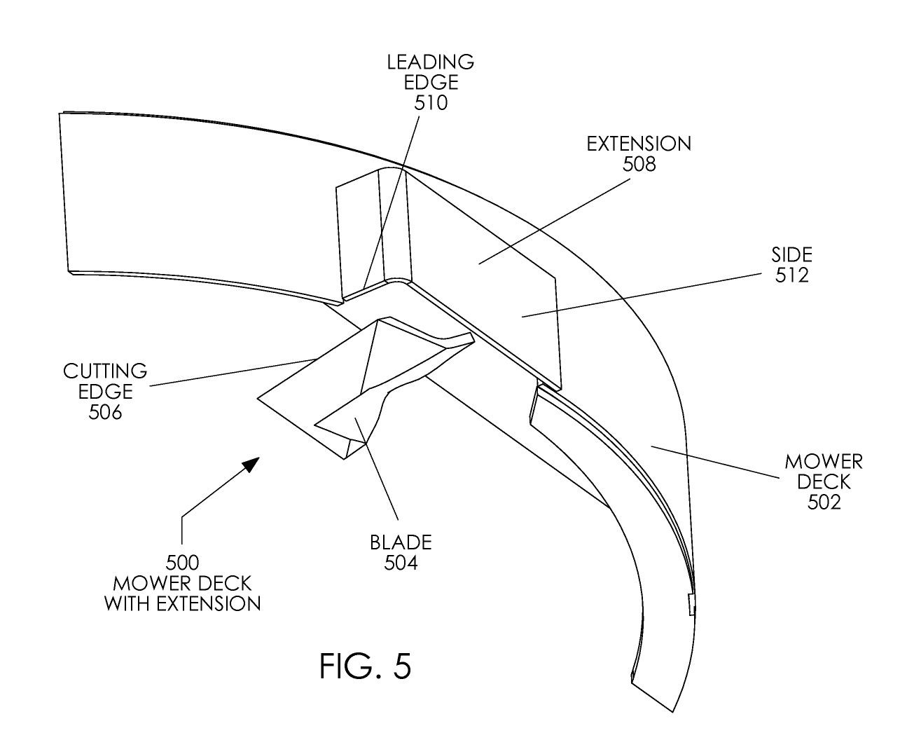

FIG. 5 is a perspective illustration of an embodiment 500 showing a mower deck with an extension. A mower deck 502 may have an extension 508 that has a leading edge 510 and a size 512. A blade 504 is illustrated as having a cutting edge 506.

The extension 508 may be an example of an extension that may not be removable and may be incorporated into the mower deck 502. In the example of embodiment 500, the extension 508 may be a formed or fabricated component that may be stamped, welded, or otherwise incorporated into the mower deck 502.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A mower deck comprising:
at least one blade having a vertical rotation axis;
a shroud over said at least one blade, said shroud having a curved leading edge centered about said vertical rotation axis, said curved leading edge defining a bottom plane for said shroud;
a leading edge extension attached to said shroud and located forward of said vertical rotation axis, said leading edge extension protruding from said curved leading edge an extension distance, said leading edge extension comprising a straight leading edge.

2. The mower deck of claim 1, said straight leading edge being at least one inch long.

3. The mower deck of claim 2, said straight leading edge being no more than three inches long.

4. The mower deck of claim 3, said straight leading edge having a lower edge parallel to said bottom plane.

5. The mower deck of claim 4, said leading edge extension being removable.

6. The mower deck of claim 4, said leading edge extension having a side edge parallel to a forward direction of travel and tangential with said curved leading edge.

7. The mower deck of claim 6, said curved leading edge being discontinuous from said straight leading edge to said side edge

8. The mower deck of claim 6, said curved leading edge being continuous from said straight leading edge to said side edge.

9. The mower deck of claim 6, said mower deck comprising one blade.

10. The mower deck of claim 6, said mower deck comprising two blades.

11. The mower deck of claim 6, said at least one blade rotating towards the direction of travel at said leading edge extension.

12. The mower deck of claim 6, said at least one blade rotating away from the direction of travel at said leading edge extension.

13. An attachment to a mower deck, said mower deck having:
at least one blade having a vertical rotation axis and a maximum radius;
a curved leading edge centered about said vertical rotation axis and defining a bottom plane for said mower deck;
a forward direction of travel;
said attachment comprising:
a vertical side parallel to said forward direction of travel; and
a leading edge from said vertical side to said curved leading edge, said leading edge having a bottom edge coincident with said bottom plane.

14. The attachment of claim 13 being removable from said mower deck.

15. The attachment of claim 13, said leading edge being within 15 degrees of perpendicular to said forward direction of travel.

16. The attachment of claim 15, said leading edge being within 5 degrees of perpendicular to said forward direction of travel.

17. The attachment of claim 13, said vertical side being no longer than 6 inches.

18. The attachment of claim 17, said leading edge being no longer than 2 inches.

19. The attachment of claim 18 further comprising:
a bottom plate parallel to said bottom plane bounded by said vertical side, said leading edge, and said curved leading edge.
